(19) United States
(12) Patent Application Publication
(10) Pub. No.: US 2026/0155282 A1
(43) Pub. Date: Jun. 4, 2026

(54) OVER-CURRENT PROTECTION DEVICECTION DEVICE

(71) Applicant: Polytronics Technology Corp., HSINCHU (TW)

(72) Inventors: Cheng-Yu TUNG, Tainan City (TW); Chingting CHIU, Taoyuan City (TW); Chia-Yuan LEE, Hsinchu City (TW); Chen-Nan LIU, Pitou Township (TW); Hsiu-Che YEN, Taoyuan City (TW); Yung-Hsien CHANG, Douliu City (TW); Yao-Te CHANG, Yunlin County (TW)

(21) Appl. No.: 19/058,421

(22) Filed: Feb. 20, 2025

(30) Foreign Application Priority Data
Dec. 3, 2024 (TW) 113146766

(51) Int. Cl. H01C 7/02; H01C 7/06; H02H 9/02

(52) U.S. Cl. CPC H01C 7/027; H01C 7/06; H02H 9/026

(57) ABSTRACT

An over-current protection device includes an electrode layer and a heat-sensitive layer. The electrode layer has a top metal layer and a bottom metal layer, and the heat-sensitive layer is laminated between them. The heat-sensitive layer exhibits a positive temperature coefficient (PTC) characteristic and includes a polymer matrix and a conductive filler. The conductive filler includes a metal compound dispersed in the polymer matrix, thereby forming an electrically conductive path in the heat-sensitive layer. The metal compound consists of a metal carbide and unavoidable impurities. The total amount of the metal carbide and unavoidable impurities is taken as 100%, and the metal carbide accounts for at least 90%.

### BACKGROUND OF THE INVENTION

### (1) Field of the Invention

The present application relates to an over-current protection device, and more specifically, to an over-current protection device with low electrical resistivity and high electrical resistance stability.

### (2) Description of the Related Art

Because the electrical resistance of conductive composite materials having a positive temperature coefficient (PTC) characteristic is very sensitive to temperature variation, they can be used as the materials for current sensing devices and have been widely applied to over-current protection devices or circuit devices. More specifically, the electrical resistance of the PTC conductive composite material remains extremely low at normal temperatures, so that the circuit or battery cell can operate normally. However, when an over-current or an over-temperature situation occurs in the circuit or cell, the electrical resistance will instantaneously increase to a high electrical resistance state (e.g., at least above 10⁴Ω), which is the so-called “trip”. Therefore, the over-current will be eliminated so as to protect the cell or the circuit device.

The basic structure of an over-current protection device consists of a PTC material layer with two electrodes bonded to two opposite sides of the PTC material layer. The PTC material layer includes a matrix and a conductive filler. The matrix consists of at least one polymer, and the conductive filler consists of carbon and/or a metal material (e.g., pure metal, alloy, or other electrically conductive metal-containing materials), uniformly dispersed in the matrix. As described above, the positive temperature coefficient characteristic of the over-current protection device primarily comes from the PTC material layer, and therefore various electrical characteristics of the over-current protection device can be adjusted by modifying the PTC material layer.

In order to attain lower electrical resistivity, the conductive filler often includes a certain proportion of the metal material. However, in terms of the raw material market, a common problem is that the metal material generally has insufficient purity, which can compromise electrical conductivity and even lead to poor electrical resistance stability in the over-current protection device. For instance, the metal material may be titanium carbide. It should be noted that titanium carbide available on the market is not actually pure titanium carbide, as one or more reactants or by-products remain from the production process. In some commonly used processes, titanium tetrachloride (TiCl₄) reacts with carbon under a hydrogen atmosphere at high temperatures to produce titanium carbide. However, residual titanium tetrachloride may remain due to incomplete reactions. It is understood that the hydrolysis of titanium tetrachloride produces hydrogen chloride, which can easily corrode components in the PTC material layer, harm the environment, or adversely affect electrical characteristics. As a result, magnesium hydroxide (Mg(OH)₂) is often added into the PTC material layer to neutralize titanium tetrachloride and prevent these issues. In other processes, titanium dioxide (TiO₂) reacts with carbon at high temperatures to produce titanium carbide. Similarly, residual titanium dioxide may remain due to incomplete reactions. It is understood that water is easily adsorbed onto the surface of titanium dioxide, thereby increasing the electrical resistance of the PTC material. The aforementioned titanium tetrachloride, titanium dioxide, and residual reactants or by-products from other processes may be referred to as impurities. That is, titanium carbide sold on the market unavoidably contains excessive impurities, which adversely affect the electrical conductivity, electrical resistance stability, and/or other electrical characteristics.

In addition, it should be noted that the electrical resistance stability of the over-current protection device is particularly important for certain products to be protected. For example, in a laptop, its motherboard is equipped with multiple USB ports, which can connect to external USB connectors for data transmission. There is a risk of overcurrent occurring when a USB port is connected to a USB connector. Therefore, an over-current protection device can be placed in series with the USB port on the motherboard to provide protection. However, it should be noted that the connection between the USB port and the USB connector is detachable, meaning the USB connector will be repeatedly inserted into and removed from the USB port during use. The frequent repetition of these connection and disconnection actions increases the risk of multiple trip events, making the electrical resistance stability of the over-current protection device especially important.

Accordingly, there is a need to develop a new type of over-current protection device with low electrical resistivity and excellent resistance stability.

### SUMMARY OF THE INVENTION

In accordance with an aspect of the present invention, an over-current protection device includes an electrode layer and a heat-sensitive layer. The electrode layer has a top metal layer and a bottom metal layer. The heat-sensitive layer is laminated between the top metal layer and the bottom metal layer. The heat-sensitive layer exhibits a positive temperature coefficient (PTC) characteristic and includes a polymer matrix and a conductive filler. The polymer matrix includes a polyolefin-based polymer. The conductive filler includes a metal compound dispersed in the polymer matrix, thereby forming an electrically conductive path in the heat-sensitive layer. The metal compound consists of a metal carbide and unavoidable impurities. The total amount of the metal carbide and the unavoidable impurities is taken as 100%, and the metal carbide accounts for at least 90%.

In an embodiment, a maximum diameter of the metal compound is smaller than 20 μm.

In an embodiment, the metal carbide is titanium carbide.

In an embodiment, the unavoidable impurities include titanium dioxide and/or titanium tetrachloride.

In an embodiment, the total volume of the heat-sensitive layer is taken as 100%, and the metal compound accounts for 50% to 60%.

In an embodiment, the total volume of the heat-sensitive layer is taken as 100%, and the polyolefin-based polymer accounts for 40% to 50%.

In an embodiment, the polyolefin-based polymer is selected from the group consisting of low density polyethylene (LDPE), medium density polyethylene (MDPE), high density polyethylene (HDPE), linear low-density polyethylene (LLDPE), polypropylene, and polybutene.

In an embodiment, the heat-sensitive layer does not include a flame retardant.

In an embodiment, the polymer matrix does not include a fluoropolymer. The fluoropolymer is selected from the group consisting of polyvinylidene difluoride, polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and a mixture or copolymer of combinations thereof.

In an embodiment, the over-current protection device has a resistance jump ratio ranging from 1.4 to 1.6. The over-current protection device has an initial electrical resistance; the over-current protection device has a first electrical resistance when cooled back to room temperature after a trip event; and the resistance jump ratio is obtained by dividing the first electrical resistance by the initial electrical resistance.

In an embodiment, the over-current protection device has a first electrical resistivity ranging from 0.006 Ω·cm to 0.018 Ω·cm, wherein the first electrical resistivity is defined as an electrical resistivity of the over-current protection device prior to any heat treatment.

In an embodiment, the over-current protection device has a second electrical resistivity ranging from 0.008 Ω·cm to 0.03 Ω·cm, wherein the second electrical resistivity is defined as an electrical resistivity of the over-current protection device after a heat treatment.

In an embodiment, the over-current protection device has a first permissible current ranging from 0.4 A/mm² to 0.9 A/mm², wherein the first permissible current is defined as a minimum current required to trip the over-current protection device per unit area at 23° C.

In an embodiment, the over-current protection device has a second permissible current ranging from 0.2 A/mm² to 0.5 A/mm², wherein the second permissible current is defined as a minimum current required to trip the over-current protection device per unit area at 85° C.

In an embodiment, the over-current protection device has a leakage current ranging from 0.04 A to 0.06 A at 85° C.

In an embodiment, the over-current protection device has a top-view area ranging from 2 mm² to 81 mm².

In an embodiment, the heat-sensitive layer has a thickness ranging from 0.13 mm to 0.2 mm.

### BRIEF DESCRIPTION OF THE DRAWINGS

The present application will be described according to the appended drawings in which:

FIG. 1 shows a cross-sectional view of an over-current protection device in accordance with an embodiment of the present invention;

FIG. 2 shows the top view of the over-current protection device shown in FIG. 1;

FIG. 3 illustrates the result of XRD analysis for a commercial sample of titanium carbide before any treatment; and

FIG. 4 illustrates the result of XRD analysis for a commercial sample of titanium carbide after a heat treatment with carbon.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

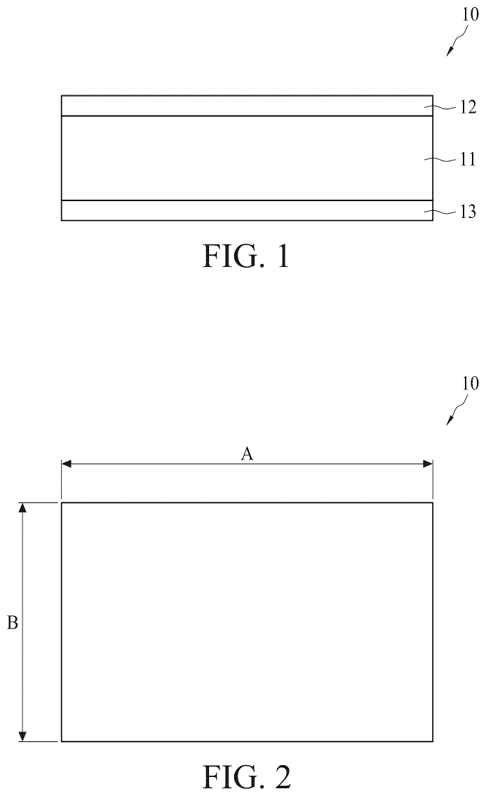

Please refer to FIG. 1. FIG. 1 shows one basic aspect of an over-current protection device 10 of the present invention. The over-current protection device 10 includes a heat-sensitive layer 11 and an electrode layer. The heat-sensitive layer 11 has a top surface and a bottom surface, and the electrode layer has a top metal layer 12 and a bottom metal layer 13 attached to the top surface and the bottom surface, respectively. Therefore, the heat-sensitive layer 11 physically contacts the top metal layer 12 and the bottom metal layer 13, and is laminated therebetween. In an embodiment, the top metal layer 12 and the bottom metal layer 13 may be composed of the nickel-plated copper foils or other conductive metals. In addition, the heat-sensitive layer 11 includes a polymer matrix and a conductive filler. The polymer matrix is an electrical insulator sensitive to heat, and the conductive filler is a conductor, by which the heat-sensitive layer 11 exhibits a PTC characteristic. During the un-tripped state of the over-current protection device 10, the conductive filler is uniformly dispersed in the polymer matrix, and particles of the conductive filler connect to each other in series, thereby forming an electrically conductive path; however, the polymer matrix rapidly expands and the crystalline region is transformed into the amorphous region when the over-current protection device 10 is subject to high temperatures, thereby cutting off the electrically conductive path.

It is noted that the conductive filler of the present invention includes a high-purity metal compound dispersed in the polymer matrix. This metal compound not only optimizes the electrical conduction of the electrically conductive path but also ensures that the over-current protection device 10 exhibits low electrical resistivity after multiple trip events, thereby achieving electrical resistance stability. More specifically, the metal compound may consist of a metal carbide and unavoidable impurities. The total amount of the metal carbide and the unavoidable impurities is taken as 100%, and the metal carbide accounts for at least 90%.

Regarding PTC materials, it is generally believed that a high-temperature sintering process is required to perform heat treatment on ceramic fillers to achieve the desired low electrical resistivity and other electrical characteristics in the subsequent production of over-current protection devices. The required temperature for the aforementioned sintering process is approximately 1400° C., and a specific atmosphere (e.g., hydrogen atmosphere) may be necessary in some cases. However, according to the specifications of the heating equipment currently used in industry (e.g., sintering furnaces), excessively high temperatures (e.g., near or above 1500° C.) can significantly reduce their service life or greatly increase the likelihood of damage. Additionally, heat treatment at higher temperatures generates a larger carbon footprint, which is not in alignment with the current trend toward sustainable development. In contrast, the present invention mixes the metal compound and carbon in specified ratios, and subjects the mixture of the metal compound and carbon to heat treatment at temperatures significantly lower than 1500° C. (i.e., around 1000° C.) under vacuum, thereby obtaining the high-purity metal compound. For example, the metal compound may be titanium carbide sold on the market (referred to as “commercial titanium carbide” for simplicity), and the term ‘metal carbide’ refers to pure metal carbide. It is understood that commercial titanium carbide is not actually pure; it consists of titanium carbide and unavoidable impurities (e.g., titanium tetrachloride, titanium dioxide, and/or titanium-containing impurities from other processes). In the present invention, these impurities may react with carbon to produce titanium carbide under specific temperatures and atmosphere. After analysis using an X-ray Diffractometer (XRD), the purity of titanium carbide in the present invention may reach at least 90%. In this way, the amount of impurities can be significantly reduced or even completely eliminated, thereby significantly increasing the purity of commercial titanium carbide. Besides concerns about electrical resistance and electrical resistance stability, titanium carbide with low purity may lead to other issues; for instance, if the purity is lower than 90% (i.e., the amount of titanium carbide is lower than 90%), these impurities make the PTC material more likely to absorb water and produce harmful gases (e.g., hydrogen chloride).

In the present invention, the mole ratio between commercial titanium carbide and carbon ranges from 1:1 to 10:1. Preferably, the proportion of commercial titanium carbide is higher than that of carbon, such as 3:1 to 5:1. The maximum diameter of the carbon particles should be smaller than 10 micrometers (μm) to prevent agglomeration, which can lead to incomplete carbonization of impurities. To further ensure the purity of titanium carbide, large particles in the impurities and residual carbon particles are screened out using a separator. Therefore, the maximum diameter of particles of the metal compound is smaller than 20 μm. This maximum diameter, set below 20 μm, also prevents the heat-sensitive layer 11 from becoming excessively thick. In one embodiment, the maximum diameter of the metal compound ranges from 14 μm to 20 μm, such as 14 μm, 14.3 μm, 14.8 μm, 15.1 μm, 15.5 μm, 16 μm, 16.6 μm, 17.3 μm, 18 μm, 18.5 μm, 19 μm, 19.6 μm, 19.9 μm, or 20 μm.

Regarding the composition of the PTC material, a polyolefin-based polymer is selected as the major constituent of the polymer matrix of the present invention, and the aforementioned metal compound is selected as the major constituent of the conductive filler. The polyolefin-based polymer is selected from the group consisting of low density polyethylene (LDPE), medium density polyethylene (MDPE), high density polyethylene (HDPE), linear low-density polyethylene (LLDPE), polypropylene, and polybutene. Preferably, the polyolefin-based polymer is low density polyethylene or high density polyethylene. In one embodiment, the total volume of the heat-sensitive layer 11 is taken as 100%, and the polyolefin-based polymer accounts for 40% to 50%, preferably ranging from 44% to 48%, such as 44%, 44.5%, 44.7%, 44.9%, 45%, 45.5%, 45.7%, 45.9%, 46%, 46.5%, 46.7%, 46.9%, 47%, 47.5%, 47.9%, or 48%. In one embodiment, the total volume of the heat-sensitive layer 11 is taken as 100%, and the metal compound accounts for 50% to 60%, preferably ranging from 52% to 56%, such as 52%, 52.1%, 52.5%, 53%, 53.1%, 53.3%, 53.5%, 54%, 54.1%, 54.3%, 54.5%, 55%, 55.1%, 55.3%, 55.5%, or 56%.

It is noted that the heat-sensitive layer 11 of the present invention does not include a flame retardant. The flame retardant is selected from the group consisting of zinc oxide, antimony oxide, aluminum oxide, silicon oxide, calcium carbonate, magnesium sulfate, barium sulfate, magnesium hydroxide, aluminum hydroxide, calcium hydroxide, and barium hydroxide. Conventionally, the flame retardant is used to reduce the flammability of the over-current protection device 10, enabling it to withstand higher currents or powers without burnout. In some cases, magnesium hydroxide even acts as an inner filler for neutralization. However, in the absence of the flame retardant, the present invention can still withstand higher currents or powers without burnout, and moreover, there is no need to consider the issue of neutralization. In this way, the composition of the PTC material is improved through its simplicity. That is, the present invention reduces the complexity of the composition while still exhibiting excellent electrical characteristics. In some embodiments, the polymer matrix of the over-current protection device 10 does not include a fluoropolymer. The fluoropolymer is selected from the group consisting of polyvinylidene difluoride, polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and a mixture or copolymer of combinations thereof. It is understood that the polyolefin-based polymer of the present invention has higher crystallinity, and therefore, its resistance recovery capability is better than that of the fluoropolymer. Moreover, the melting point of the polyolefin-based polymer is often lower than that of the fluoropolymer, and correspondingly, the protection temperature (i.e., the trip temperature) of the polyolefin-based polymer is also lower. As a result, in some embodiments, the over-current protection device 10 of the present invention is designed for a low protection temperature and high resistance stability, thereby excluding the fluoropolymer.

By improving the heat-sensitive layer 11 as described above, the over-current protection device 10 of the present invention exhibits excellent electrical resistance stability, low electrical resistivity, high electrical conductivity, low leakage current, and other advantageous electrical characteristics. The details are provided below.

In the present invention, the electrical resistance stability is assessed using a parameter called “resistance jump ratio (i.e., Rⱼᵤₘₚ).” The over-current protection device 10 exhibits a resistance jump ratio ranging from 1.4 to 1.6, which is significantly lower than that of the conventional over-current protection device (typically 1.7). More specifically, the over-current protection device 10 has an initial electrical resistance at room temperature before any trip event, and has a first electrical resistance when cooled back to room temperature after one trip event (e.g., an event caused by high temperatures of a reflow process); and the resistance jump ratio is obtained by dividing the first electrical resistance by the initial electrical resistance. A lower resistance jump ratio indicates a better ability of the over-current protection device 10 to recover to a low electrical resistance state, demonstrating superior resistance recovery capability.

As for electrical resistivity, the over-current protection device 10 of the present invention maintains it within a lower range, regardless of whether heat treatment is applied. More specifically, the over-current protection device 10 has a first electrical resistivity ranging from 0.006 Ω·cm to 0.018 Ω·cm, wherein the first electrical resistivity is defined as an electrical resistivity of the over-current protection device 10 prior to any heat treatment. The over-current protection device 10 has a second electrical resistivity ranging from 0.008 Ω·cm to 0.03 Ω·cm, wherein the second electrical resistivity is defined as an electrical resistivity of the over-current protection device 10 after the heat treatment. The heat treatment may occur due to high temperatures during device assembly (e.g., the aforementioned reflow process).

Regarding high electrical conductivity, the over-current protection device 10 of the present invention allows a larger current to pass through when it is not tripped, thus requiring a higher minimum current for activation (i.e., trip). Therefore, the minimum current for activation, as mentioned above, is defined as “permissible current” in the context, and it shows a higher trend at different temperatures. The over-current protection device 10 has a first permissible current ranging from 0.4 A/mm² to 0.9 A/mm², wherein the first permissible current is defined as a minimum current required to trip the over-current protection device 10 per unit area at 23° C. The over-current protection device 10 has a second permissible current ranging from 0.2 A/mm² to 0.5 A/mm², wherein the second permissible current is defined as a minimum current required to trip the over-current protection device 10 per unit area at 85° C. In addition, high-temperature environments further highlight the other advantages of the present invention. For example, at 85° C., the over-current protection device 10 has a leakage current ranging from 0.04 A to 0.06 A, which is lower than that of the conventional one.

Please refer to FIG. 2, which shows the top view of the over-current protection device 10 shown in FIG. 1. The over-current protection device 10 has a length A and a width B, and the top-view area “A×B” of the over-current protection device 10 is substantially equivalent to the top-view area of the heat-sensitive layer 11. The heat-sensitive layer 11 may have a top-view area ranging from 2 mm² to 81 mm² based on the size of different products. For example, the top-view area “A×B” may be 1.5×1.5 mm², 2×2 mm², 2.3×2.3 mm², 2.5×3 mm², 2.8×3.5 mm², 4×4 mm², 5×5 mm², 5.1×6.1 mm², 5×7 mm², 7.62×7.62 mm², 8.2×7.15 mm², 7.3×9.5 mm², 7.62×9.35 mm², or 9×9 mm². In addition, the total thickness of the over-current protection device 10 (i.e., the total thickness of the top metal layer 12, the heat-sensitive layer 11, and the bottom metal layer 13) ranges from 0.2 mm to 0.27 mm. More specifically, the thickness of each of the top metal layer 12 and the bottom metal layer 13 is 0.035 mm, and the thickness of the heat-sensitive layer 11 correspondingly ranges from 0.13 mm to 0.2 mm, such as 0.13 mm, 0.14 mm, 0.15 mm, 0.16 mm, 0.17 mm, 0.18 mm, 0.19 mm, or 0.2 mm. In a preferred embodiment, the top-view area of the over-current protection device 10 ranges from 7.5 mm² to 16 mm²; the thickness of each of the top metal layer 12 and the bottom metal layer 13 is 0.035 mm; and the thickness of the heat-sensitive layer 11 is 0.15 mm. Considering the measurement error and the permissible error tolerance, the thickness of the heat-sensitive layer 11 of the preferred embodiment may range from 0.14 mm to 0.16 mm. In other embodiments, thicker metal layers are used, and therefore the thickness of each of the top metal layer 12 and the bottom metal layer 13 may be 0.04 mm. It is noted that the thickness of a single metal layer (i.e., the top metal layer 12 or the bottom metal layer 13) does not exceed 0.05 mm, as it significantly raises the cost of mass production without contributing to the protection stability (e.g., resistance jump ratio) that the present invention aims to achieve. It is understood that the present invention can apply to any size of the over-current protection device 10 described above to achieve the same technical effect. The over-current protection device 10 can be processed into different device types commonly used in the industry, such as surface-mount device (SMD), axial-leaded device (ALD), radial-leaded device (RLD), or other device types, depending on the requirements.

In order to provide a more specific description of the technical content of the present invention, Tables 1 to 7 shown below are further discussed using actual verification data.

TABLE 1
Composition of material for heat treatment

| | Mole percentage | | | Weight percentage | |
|---|---|---|---|---|---|
| Group | TiC | CB | ratio | TiC | CB |
| E1 | 90.91% | 9.09% | 10:1 | 98.04% | 1.96% |
| E2 | 83.33% | 16.67% | 5:1 | 96.15% | 3.85% |
| E3 | 75% | 25% | 3:1 | 93.74% | 6.26% |
| E4 | 50% | 50% | 1:1 | 83.31% | 16.69% |
| C1 | 100% | 0% | — | 100% | 0% |

As shown in Table 1, groups E1 to E4 are the embodiments E1 to E4 of the present invention, and group C1 is the comparative example C1. In Table 1, TiC refers to titanium carbide sold on the market (referred to as “commercial titanium carbide” for simplicity), and CB refers to carbon. Commercial titanium carbide is mixed with carbon in various ratios for subsequent heat treatments. In the embodiment E1, the mole percentages between titanium carbide and carbon are 90.91% and 9.09% (approximately 10:1), while their weight percentages are 98.04% and 1.96%, respectively. In the embodiment E2, the mole percentages between titanium carbide and carbon are 83.33% and 16.67% (approximately 5:1), while their weight percentages are 96.15% and 3.85%, respectively. In the embodiment E3, the mole percentages between titanium carbide and carbon are 75% and 25% (approximately 3:1), while their weight percentages are 93.74% and 6.26%, respectively. In the embodiment E4, the mole percentages between titanium carbide and carbon are 50% and 50% (approximately 1:1), while their weight percentages are 83.31% and 16.69%, respectively. The comparative example C1 is served as a control group, and therefore its titanium carbide is not mixed with carbon.

TABLE 2
Same treated temperature and purity of titanium carbide

| | | | Amount in percentage at the corresponding 2θ | | | | | | | |
|---|---|---|---|---|---|---|---|---|---|---|
| Group | Material | Temperature | 25.56° | 36.14° | 41.9° | 55.16° | 60.62° | 70.56° | 76.34° | Purity |
| E5 | E1 | 1050° C. | 1.1% | 33.5% | 37.6% | 0.4% | 12.5% | 9.8% | 5.2% | 98.5% |
| E6 | E2 | 1050° C. | 0% | 32.3% | 42.1% | 0% | 12.1% | 9% | 4.6% | 100% |
| E7 | E3 | 1050° C. | 0% | 33.7% | 40.1% | 0% | 12.3% | 9.3% | 4.6% | 100% |
| E8 | E4 | 1050° C. | 0% | 32.8% | 40.3% | 0% | 12.4% | 9.6% | 4.9% | 100% |
| C2 | C1 | 1050° C. | 6.7% | 28.5% | 32.8% | 4.3% | 15.6% | 8% | 4.1% | 89% |

As shown in Table 2, each group undergoes heat treatment at the same temperature (1050° C.) in a vacuum environment. Groups E5 to E8 are the embodiments E5 to E8 of the present invention, and the materials used for heat treatment in these groups are derived from the embodiments E1 to E4. Group C2 is the comparative example C2, and the material used for heat treatment in this group is derived from the comparative example C1. After heat treatment, the materials are analyzed by XRD. Through XRD, the light intensity corresponding to a particular diffraction angle (2θ) of a sample can be obtained, which allows the material composition to be characterized. It is known that the diffraction angles (2θ) of titanium carbide are 36.14°, 41.9°, 60.62°, 70.56°, and 76.34°, while the diffraction angles (2θ) of impurities are 25.56° and 55.16°. If the total intensity of all the aforementioned diffraction angles is taken as 100%, the total intensity at 36.14°, 41.9°, 60.62°, 70.56°, and 76.34° can be calculated, which can be defined as the purity of titanium carbide. The total intensity at 36.14°, 41.9°, 60.62°, 70.56°, and 76.34° can also be referred to as the amount of titanium carbide, corresponding to the amount of the metal carbide mentioned above. The total intensity at 25.56° and 55.16° of the impurities is referred to as the amount of the impurities, corresponding to the amount of the unavoidable impurities mentioned above. For instance, in the embodiment E5, the intensities at 36.14°, 41.9°, 60.62°, 70.56°, and 76.34° account for 33.5%, 37.6%, 12.5%, 9.8%, and 5.2%, respectively, totaling 98.5%. In other words, the amount of titanium carbide in the embodiment E5 accounts for 98.5%, representing 98.5% purity. Calculated in the same manner, the amount of titanium carbide in each of the embodiments E6 to E8 is 100%, representing 100% purity. In contrast, the purity of titanium carbide in the comparative example C2 is only 89%, indicating that the purity of titanium carbide is significantly lower when commercial titanium carbide undergoes heat treatment without carbon.

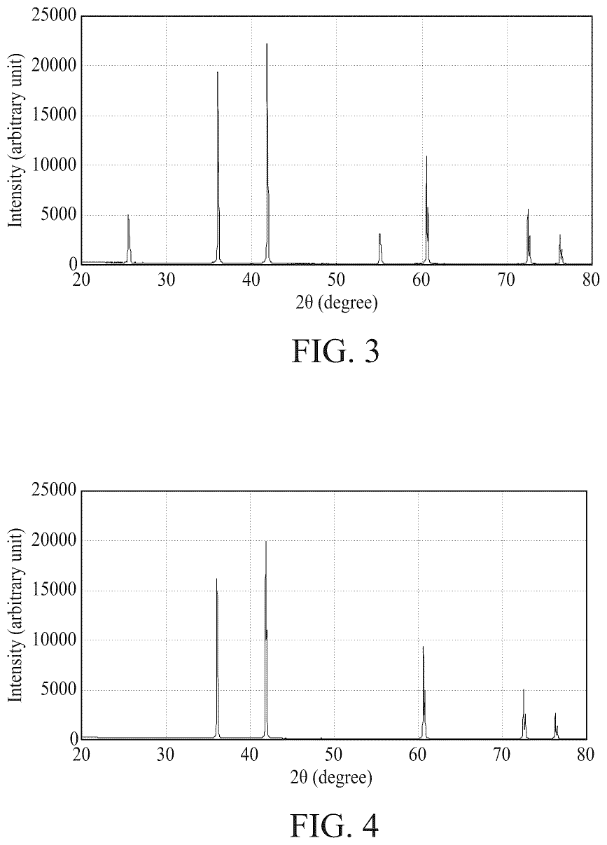

To describe the results of XRD analysis more clearly, please refer to FIG. 3 and FIG. 4. FIG. 3 illustrates the result of XRD analysis for the comparative example C2, while FIG. 4 illustrates the result of XRD analysis for the embodiment E6. The horizontal axis indicates the diffraction angle (2θ) represented by “degree (°)”, and the vertical axis indicates the intensity represented by “arbitrary unit (a.u.).” As described above, peaks corresponding to titanium carbide are observed at 36.14°, 41.9°, 60.62°, 70.56°, and 76.34°, while peaks corresponding to the impurities are observed at 25.56° and 55.16°. In FIG. 3, the intensities at 25.56° and 55.16° are 4568 and 2884, respectively, while the intensities at 36.14°, 41.9°, 60.62°, 70.56°, and 76.34° are 19321, 22221, 10601, 5452, and 2775, respectively. In FIG. 4, the intensities at 25.56° and 55.16° are both 0, while the intensities at 36.14°, 41.9°, 60.62°, 70.56°, and 76.34° are 16188, 21089, 6048, 4528, and 2284, respectively. From the above, it is evident that titanium carbide with high purity can be obtained in accordance with the present invention.

TABLE 3
Different treated temperatures and particle size and purity of titanium carbide

| | | | Particle size distribution | | | | |
|---|---|---|---|---|---|---|---|
| Group | Material | Temperature | D(0.1) | D(0.5) | D(0.9) | D(max) | Purity |
| E9 | E2 | 1050° C. | 1.42 μm | 3.98 μm | 8.61 μm | 15.1 μm | 100% |
| E10 | E2 | 1150° C. | 1.42 μm | 3.98 μm | 8.61 μm | 15.1 μm | 100% |
| E11 | E2 | 1200° C. | 1.66 μm | 4.18 μm | 8.90 μm | 17.3 μm | 100% |
| E12 | E2 | 1250° C. | 1.89 μm | 4.57 μm | 9.85 μm | 19.9 μm | 100% |
| E13 | E4 | 1250° C. | 1.56 μm | 4.34 μm | 8.84 μm | 14.3 μm | 100% |

Based on the results described above, additional tests are further performed. Each group undergoes heat treatment at a different temperature, and the distribution of particle sizes is controlled. Groups E9 to E13 are the embodiments E9 to E13 of the present invention. The material used for heat treatment in the embodiments E9 to E12 is derived from the embodiment E2, while the material used for heat treatment in the embodiment E13 is derived from the embodiment E4. The embodiments E9 to E13 undergo heat treatment at temperatures ranging from 1050° C. to 1250° C. in a vacuum environment. It is noted that after the aforementioned heat treatment, purified titanium carbide from the commercial titanium carbide and carbon is formed. The purified titanium carbide is then crushed by a grinding machine and finally sorted by a separator (e.g., cyclone separator), thereby controlling the particle sizes of titanium carbide within the desired range. Particle size distribution is measured by the particle size analyzer (commercialized brand name Malvern Mastersizer 2000). “D” stands for “Distribution of particle size”, and the number within brackets after “D” refers to the proportion of the particles. The total number of particles is calculated as 1, so 0.1, 0.5 and 0.9 refer to 10%, 50% and 90%, respectively. For example, D (0.1) means that 10% of particles are smaller than the values of D (0.1) listed in Table 3. D (0.5) and D (0.9) are interpreted in the same way. As for D (max), it refers to the maximum particle diameter (or maximum diameter for simplicity) present among all the particles. In addition, D (0.5) stands for the middle value of particle size distribution, that is, the median diameter. As shown in Table 3, the purity of titanium carbide is 100% in the embodiments E9 to E13, and its maximum diameter is smaller than 20 μm, ranging from 14 μm to 20 μm.

Next, the purified titanium carbide is applied to the PTC material. The details of the results are shown in the following Tables 4 to 7.

TABLE 4
Composition of heat-sensitive layer (1) and device resistance

| | Composition | | | | |
|---|---|---|---|---|---|
| | HDPE | TiC | Source | Rᵢ | ρᵢ |
| Group | (vol %) | (vol %) | of TiC | (Ω) | (Ω · cm) |
| E14 | 44.5 | 55.5 | E9 | 0.003954 | 0.017613 |
| E15 | 44.5 | 55.5 | E10 | 0.001844 | 0.008214 |
| E16 | 44.5 | 55.5 | E11 | 0.001285 | 0.005724 |
| E17 | 44.5 | 55.5 | E12 | 0.001150 | 0.005123 |
| E18 | 44.5 | 55.5 | E13 | 0.002098 | 0.009346 |

Table 4 shows the composition of the heat-sensitive layer in volume percentages for groups E14 to E18 (i.e., the embodiments E14 to E18). The polymer matrix is high density polyethylene (HDPE), and the conductive filler is the purified titanium carbide (TiC) from the embodiments E9 to E13. In this test, the material ratios in the heat-sensitive layer are fixed to preliminarily verify the resistance characteristics. The manufacturing process of the over-current protection devices is described below. According to the composition shown in Table 4, materials are prepared and put into HAAKE twin screw blender for blending. The blending temperature is 215° C., the time for pre-mixing is 3 minutes, and the blending time is 15 minutes. The conductive polymer after being blended is pressed into a sheet by a hot press machine at a temperature of 210° C. and a pressure of 150 kg/cm². The sheet is then cut into pieces of about 20 cm×20 cm, and two nickel-plated copper foils are laminated to two sides of the sheet with the hot press machine at a temperature of 210° C. and a pressure of 150 kg/cm², by which a three-layered structure is formed. Then, the sheet with the nickel-plated copper foils is punched into PTC chips, each of which is the over-current protection device. Each sample of the over-current protection device has the length of 2.8 mm and the width of 3.5 mm (i.e., top-view area is 9.8 mm²), and the thickness thereof is 0.22 mm, wherein the thickness of the heat-sensitive layer is 0.15 mm. Then, the PTC chips are subjected to electron beam irradiation of 15 kGy (irradiation dose can be adjusted depending on the requirement). After irradiation, the following measurements are performed by taking fifteen PTC chips as samples to be tested for each group.

“Rᵢ” refers to the initial electrical resistance of the over-current protection device at room temperature. In addition, the electrical resistivity formula is ρ=R×A/L, where “R” is electrical resistance, “L” is length (thickness), and “A” is area. Accordingly, the electrical resistivity ρᵢ can be calculated based on Rᵢ. It is known that there is difficulty in achieving an electrical resistivity lower than 0.2 Ω·cm when the conductive filler consists of pure carbon in the over-current protection device. In Table 4, the electrical resistivity of the embodiments E14 to E18 falls within the range from 0.005 Ω·cm to 0.02 Ω·cm, which is significantly lower than the aforementioned 0.2 Ω·cm. Therefore, each one of these embodiments exhibits extremely low electrical resistivity. In particular, the embodiments E16 and E17 exhibit the lowest values, which are 0.005724 Ω·cm and 0.005123 Ω·cm, respectively. The purified titanium carbide of the embodiments E16 and E17 comes from the embodiments E11 and E12, respectively. Subsequent tests will modify the composition of the heat-sensitive layer using these two types of titanium carbide. Please refer to the following Table 5 to Table 7.

TABLE 5
Composition of heat-sensitive layer (2) and various electrical characteristics

| | Composition | | | | | | | |
|---|---|---|---|---|---|---|---|---|
| | HDPE | TiC | Source | Rᵢ | R₁ | ρᵢ | ρ₁ | |
| Group | (vol %) | (vol %) | of TiC | (Ω) | (Ω) | (Ω · cm) | (Ω · cm) | Rⱼᵤₘₚ |
| E19 | 44.5 | 55.5 | E11 | 0.00152 | 0.00213 | 0.00677 | 0.00948 | 1.40 |
| E20 | 44.5 | 55.5 | E12 | 0.00135 | 0.00202 | 0.00602 | 0.00899 | 1.49 |
| E21 | 47 | 53 | E12 | 0.00179 | 0.00282 | 0.00796 | 0.01254 | 1.57 |
| E22 | 47.9 | 52.1 | E12 | 0.00332 | 0.00485 | 0.01477 | 0.02158 | 1.46 |
| E23 | 49.8 | 50.2 | E12 | 0.00386 | 0.00547 | 0.01718 | 0.02436 | 1.42 |
| C3 | 44.5 | 55.5 | C2 | 0.00505 | 0.00858 | 0.01980 | 0.03362 | 1.70 |

TABLE 6
Electrical characteristics of over-current protection device at 23° C.

| | Iₜᵣᵢₚ₁ | Iₜᵣᵢₚ₂ | Iₜᵣᵢₚ₃ | Leakage current | Iₜᵣᵢₚ₁/Surface area | Wₜᵣᵢₚ₁/Surface area |
|---|---|---|---|---|---|---|
| Group | (A) | (A) | (A) | (A) | (A/mm²) | (W/mm²) |
| E19 | 7.48 | 6.28 | 5.58 | 0.1322 | 0.763 | 4.580 |
| E20 | 8.44 | 8.19 | 7.85 | 0.1198 | 0.861 | 5.167 |
| E21 | 6.91 | 6.37 | 5.78 | 0.1230 | 0.705 | 4.231 |
| E22 | 5.38 | 5.01 | 4.77 | 0.1375 | 0.549 | 3.294 |
| E23 | 4.88 | 4.30 | 3.92 | 0.1207 | 0.498 | 2.988 |
| C3 | 3.78 | 3.55 | 3.34 | 0.1298 | 0.386 | 2.314 |

TABLE 7
Electrical characteristics of over-current protection device at 85° C.

| | Iₜᵣᵢₚ₁ | Iₜᵣᵢₚ₂ | Iₜᵣᵢₚ₃ | Leakage current | Iₜᵣᵢₚ₁/Surface area | Wₜᵣᵢₚ₁/Surface area |
|---|---|---|---|---|---|---|
| Group | (A) | (A) | (A) | (A) | (A/mm²) | (W/mm²) |
| E19 | 3.56 | 3.02 | 2.60 | 0.0565 | 0.363 | 2.180 |
| E20 | 4.25 | 3.98 | 3.81 | 0.0499 | 0.434 | 2.602 |
| E21 | 3.31 | 2.97 | 2.85 | 0.0540 | 0.338 | 2.027 |
| E22 | 2.57 | 2.12 | 1.78 | 0.0512 | 0.262 | 1.573 |
| E23 | 2.00 | 1.82 | 1.62 | 0.0558 | 0.204 | 1.224 |
| C3 | 1.87 | 1.55 | 1.32 | 0.0726 | 0.191 | 1.145 |

Table 5 shows the composition of the heat-sensitive layer in volume percentages for the groups E19 to E23 (i.e., the embodiments E19 to E23) and the group C3 (i.e., the comparative example C3). The polymer matrix of each group is high density polyethylene, and the conductive filler is the titanium carbide purified under different conditions. The purified titanium carbide of the embodiment E19 comes from the embodiment E11, and the purified titanium carbide of the embodiments E20 to E23 comes from the embodiment E12. The purified titanium carbide of the comparative example C3 comes from the comparative example C2, which is commercial titanium carbide with low purity and served as a control group. The manufacturing process is the same as previously mentioned, and the details are not described herein. The only difference is that the thickness of the heat-sensitive layer must be adjusted to 0.18 mm when using the composition of the comparative example C3, resulting in a total thickness of 0.25 mm for its over-current protection device. If the thickness of the heat-sensitive layer of the comparative example C3 is set to 0.15 mm, the same as in the embodiments E19 to E23, it burns out easily under the same applied voltage, making its data unavailable for comparison. Considering the measurement error and the permissible error tolerance, the percentage of high density polyethylene may range from 40% to 50%, and the percentage of titanium carbide may range from 50% to 60%. Within the above ranges, the over-current protection device can achieve the same or similar technical effects. Accordingly, the present invention demonstrates superior voltage endurance capability with the same thickness. For example, in the tests shown in Table 6 and Table 7, the applied voltage is 6 volts (V). To prevent burnout, the thickness of the heat-sensitive layer in the over-current protection device of the comparative example C3 or other conventional over-current protection devices must be at least 0.18 mm or even 0.2 mm. However, the over-current protection device of the present invention remains intact without burnout, even when the thickness of its heat-sensitive layer is reduced to 0.15 mm. The same applies when a higher voltage endurance capability is required. For example, to allow the device to withstand a voltage of 16 V without burnout, the thickness of the heat-sensitive layer of the comparative example C3 or other conventional over-current protection devices must be approximately 0.4 mm, whereas the heat-sensitive layer of the present invention can be made with a thickness of just 0.33 mm. By the way, in order to increase electrical conductivity, a conventional over-current protection device may adjust the volume percentage of conductive filler to over 62%, or the weight percentage to over 89%. However, this can cause the PTC material to become too rigid, making it prone to cracking during the pressing process. In addition to preventing the aforementioned drawbacks, the present invention reduces the thickness of the heat-sensitive layer and the content of the conductive filler, which helps decrease material usage, thereby lowering the cost of mass production.

Rᵢ and ρᵢ are previously defined and are not described in detail herein. “R₁” refers to the electrical resistance after cooling back to room temperature following a reflow process. Temperatures in the reflow process range from 140° C. to 300° C., with a processing time of about 5 minutes. According to the electrical resistivity formula, the electrical resistivity ρ₁ can be calculated based on R₁. ρᵢ corresponds to the first electrical resistivity, while ρ₁ corresponds to the second electrical resistivity, as previously mentioned. In Table 5, both in the initial state and after the reflow process, the embodiments E19 to E23 of the present invention exhibit lower electrical resistivities. In the embodiments E19 to E23, ρᵢ ranges from 0.00602 Ω·cm to 0.1718 Ω·cm, which is significantly lower than ρᵢ of the comparative example C3 (0.0198 Ω·cm). After the reflow process, ρ₁ of the embodiments E19 to E23 ranges from 0.00899 Ω·cm to 0.02436 Ω·cm, which is also significantly lower than ρ₁ of the comparative example C3 (0.03362 Ω·cm). More importantly, after the reflow process, the embodiments E19 to E23 can recover to a state with lower electrical resistance. As shown in Table 5, “Rⱼᵤₘₚ” refers to the value calculated by dividing R₁ by Rᵢ, representing the resistance jump ratio as previously mentioned. Rᵢ corresponds to the initial electrical resistance, while R₁ corresponds to the first electrical resistance, as previously mentioned. A lower electrical resistance jump ratio indicates a better ability of the over-current protection device to recover to a low electrical resistance state, demonstrating superior resistance recovery capability. In the embodiments E19 to E23, Rⱼᵤₘₚ ranges from 1.4 to 1.57. As for the comparative example C3, Rⱼᵤₘₚ is 1.7. Clearly, the devices of the embodiments E19 to E23 exhibit superior recovery to their original low-resistance state after tripping.

Please refer to Table 6 and Table 7, which show the electrical characteristics of each over-current protection device at different temperatures.

“Iₜᵣᵢₚ₁” refers to the minimum current required to trigger the first trip event of the over-current protection device. “Iₜᵣᵢₚ₂” refers to the minimum current required to trigger the second trip event of the over-current protection device. “Iₜᵣᵢₚ₃” refers to the minimum current required to trigger the third trip event of the over-current protection device. In addition, during the trip event, the current of the over-current protection device may not be completely cut off and a leakage current may still pass through it. The leakage current is measured during the third trip event of the over-current protection device. “Iₜᵣᵢₚ₁/Surface area” refers to the value calculated by dividing Iₜᵣᵢₚ₁ by the top-view area of the over-current protection device (9.8 mm²). Moreover, the applied voltage is 6 V, and therefore the minimum power required to trigger the first trip event per unit area, represented as Wₜᵣᵢₚ₁/Surface area, can be obtained.

Table 6 shows the electrical characteristics of each over-current protection device at 23° C. In the embodiments E19 to E23 of the present invention, Iₜᵣᵢₚ₁ ranges from 4.88 A to 8.44 A at 23° C.; Iₜᵣᵢₚ₂ ranges from 4.3 A to 8.19 A at 23° C.; and Iₜᵣᵢₚ₃ ranges from 3.92 A to 7.85 A at 23° C. In contrast, Iₜᵣᵢₚ₁, Iₜᵣᵢₚ₂, and Iₜᵣᵢₚ₃ values of the comparable example C3 at 23° C. are all significantly lower than the minimum values of those observed in the embodiments E19 to E23. It can be concluded that the same trend applies to the minimum current and minimum power required to trigger the trip event per unit area. In the embodiments E19 to E23 of the present invention, Iₜᵣᵢₚ₁/Surface area at 23° C. ranges from 0.498 A/mm² to 0.861 A/mm², and Wₜᵣᵢₚ₁/Surface area at 23° C. ranges from 2.988 W/mm² to 5.167 W/mm², both of which are higher than those of the comparable example C3. Iₜᵣᵢₚ₁/Surface area at 23° C. corresponds to the first permissible current as previously mentioned. The required current to trip the over-current protection device of the present invention is higher. In other words, the over-current protection device of the present invention allows a larger current to pass through when it is not tripped, withstanding greater applied current and applied power without burnout.

Table 7 shows the electrical characteristics of each over-current protection device at 85° C. In the embodiments E19 to E23 of the present invention, Iₜᵣᵢₚ₁ ranges from 2 A to 4.25 A at 85° C.; Iₜᵣᵢₚ₂ ranges from 1.82 A to 3.98 A at 85° C.; and Iₜᵣᵢₚ₃ ranges from 1.62 A to 3.81 A at 85° C. In contrast, Iₜᵣᵢₚ₁, Iₜᵣᵢₚ₂, and Iₜᵣᵢₚ₃ values of the comparable example C3 at 85° C. are all significantly lower than the minimum values of those observed in the embodiments E19 to E23. It can be concluded that the same trend applies to the minimum current and minimum power required to trigger the trip event per unit area. In the embodiments E19 to E23 of the present invention, Iₜᵣᵢₚ₁/Surface area at 85° C. ranges from 0.204 A/mm² to 0.434 A/mm², and Wₜᵣᵢₚ₁/Surface area at 85° C. ranges from 1.224 W/mm² to 2.602 W/mm², both of which are higher than those of the comparable example C3. Iₜᵣᵢₚ₁/Surface area at 85° C. corresponds to the second permissible current as previously mentioned. Under the higher temperature, the required current to trip the over-current protection device of the present invention is higher. In other words, the over-current protection device of the present invention allows a larger current to pass through when it is not tripped, withstanding greater applied current and applied power without burnout. In addition, it is noted that in the embodiments E19 to E23, the leakage current remains below 0.057 A, significantly lower than that of the comparable example C3 (0.0726 A), indicating that the over-current protection device of the present invention has better performance in cutting off the current flow. From the above, the over-current protection device of the present invention demonstrates its advantages at high temperatures.

The above-described embodiments of the present invention are intended to be illustrative only. Numerous alternative embodiments may be devised by persons skilled in the art without departing from the scope of the following claims.

What is claimed is:

1. An over-current protection device, comprising:
an electrode layer having a top metal layer and a bottom metal layer; and
a heat-sensitive layer laminated between the top metal layer and the bottom metal layer, wherein the heat-sensitive layer exhibits a positive temperature coefficient (PTC) characteristic and comprises:
a polymer matrix comprising a polyolefin-based polymer; and
a conductive filler comprising a metal compound dispersed in the polymer matrix, thereby forming an electrically conductive path in the heat-sensitive layer, wherein:
the metal compound consists of a metal carbide and unavoidable impurities; and
the total amount of the metal carbide and the unavoidable impurities is taken as 100%, and the metal carbide accounts for at least 90%.

2. The over-current protection device of claim 1, wherein a maximum diameter of the metal compound is smaller than 20 μm.

3. The over-current protection device of claim 1, wherein the metal carbide is titanium carbide.

4. The over-current protection device of claim 1, wherein the unavoidable impurities comprise titanium dioxide and/or titanium tetrachloride.

5. The over-current protection device of claim 1, wherein the total volume of the heat-sensitive layer is taken as 100%, and the metal compound accounts for 50% to 60%.

6. The over-current protection device of claim 5, wherein the total volume of the heat-sensitive layer is taken as 100%, and the polyolefin-based polymer accounts for 40% to 50%.

7. The over-current protection device of claim 1, wherein the polyolefin-based polymer is selected from the group consisting of low density polyethylene (LDPE), medium density polyethylene (MDPE), high density polyethylene (HDPE), linear low-density polyethylene (LLDPE), polypropylene, and polybutene.

8. The over-current protection device of claim 1, wherein the heat-sensitive layer does not comprise a flame retardant.

9. The over-current protection device of claim 1, wherein the polymer matrix does not comprise a fluoropolymer, wherein the fluoropolymer is selected from the group consisting of polyvinylidene difluoride, polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and a mixture or copolymer of combinations thereof.

10. The over-current protection device of claim 1, wherein the over-current protection device has a resistance jump ratio ranging from 1.4 to 1.6, wherein:
the over-current protection device has an initial electrical resistance;
the over-current protection device has a first electrical resistance when cooled back to room temperature after a trip event; and
the resistance jump ratio is obtained by dividing the first electrical resistance by the initial electrical resistance.

11. The over-current protection device of claim 1, wherein the over-current protection device has a first electrical resistivity ranging from 0.006 Ω·cm to 0.018 Ω·cm, wherein the first electrical resistivity is defined as an electrical resistivity of the over-current protection device prior to any heat treatment.

12. The over-current protection device of claim 1, wherein the over-current protection device has a second electrical resistivity ranging from 0.008 Ω·cm to 0.03 Ω·cm, wherein the second electrical resistivity is defined as an electrical resistivity of the over-current protection device after a heat treatment.

13. The over-current protection device of claim 1, wherein the over-current protection device has a first permissible current ranging from 0.4 A/mm² to 0.9 A/mm², wherein the first permissible current is defined as a minimum current required to trip the over-current protection device per unit area at 23° C.

14. The over-current protection device of claim 1, wherein the over-current protection device has a second permissible current ranging from 0.2 A/mm² to 0.5 A/mm², wherein the second permissible current is defined as a minimum current required to trip the over-current protection device per unit area at 85° C.

15. The over-current protection device of claim 14, wherein the over-current protection device has a leakage current ranging from 0.04 A to 0.06 A.

16. The over-current protection device of claim 1, wherein the over-current protection device has a top-view area ranging from 2 mm² to 81 mm².

17. The over-current protection device of claim 1, wherein the heat-sensitive layer has a thickness ranging from 0.13 mm to 0.2 mm.
